(19) United States
(12) Patent Application Publication
(10) Pub. No.: US 2025/0085398 A1
(43) Pub. Date: Mar. 13, 2025

(54) CANTILEVERED SENSOR ASSEMBLY

(71) Applicant: Ford Global Technologies, LLC, Dearborn, MI (US)

(72) Inventors: Michael Robertson, JR., Garden City, MI (US); Segundo Baldovino, Novi, MI (US); Venkatesh Krishnan, Canton, MI (US)

(73) Assignee: Ford Global Technologies, LLC, Dearborn, MI (US)

(21) Appl. No.: 18/466,102

(22) Filed: Sep. 13, 2023

(51) Int. Cl. G01S 7/481; B60S 1/50; B60S 1/56; G01S 7/497; G01S 17/931

(52) U.S. Cl. CPC G01S 7/4813; B60S 1/50; B60S 1/56; G01S 7/497; G01S 17/931; G01S 2007/4977

(57) ABSTRACT

A sensor assembly can include a bracket mounted to a vehicle roof in an attachment area of the vehicle roof. The bracket may cover the attachment area and the bracket may include a cantilevered portion extending in a vehicle-forward direction from a forwardmost point of the attachment area. A sensor can be mounted to, or within, the cantilevered portion forward of the forwardmost point.

### BACKGROUND

Autonomous and semi-autonomous vehicles typically include a variety of sensors. Some sensors detect the position or orientation of the vehicle, for example, global positioning system (GPS) sensors; accelerometers, such as piezo-electric or microelectromechanical systems; gyroscopes such as rate, ring laser, or fiber-optic gyroscopes; inertial measurement units; and magnetometers. Some sensors detect objects external to a vehicle, for example, radar sensors, cameras, and light detection and ranging (lidar) devices. Sensors may be positioned at locations of a vehicle to provide a field-of-view of an environment external to the vehicle.

### BRIEF DESCRIPTION OF THE DRAWINGS

FIG. 1 is a block diagram of an example vehicle having a cantilevered sensor assembly.

FIG. 2 is a perspective view showing a cantilevered sensor assembly mounted on a vehicle roof.

FIG. 3 is a side view showing airflow in relation to top and bottom panels of a cantilevered sensor assembly.

FIG. 4 is a front view of a cantilevered sensor assembly mounted to a vehicle roof.

FIG. 5 is an exploded perspective view of a cantilevered sensor assembly showing cooling fans and cleaning nozzles.

FIG. 6 is a bottom perspective view of airflow across the surface of a sensor of a cantilevered sensor assembly.

FIG. 7 is a cross-sectional side view showing an air passage internal to a cantilevered sensor assembly.

FIG. 8 is a side view of a cantilevered sensor assembly showing a vertical extent of a field-of-view of the sensor.

### DETAILED DESCRIPTION

An example sensor assembly can include a vehicle roof, a bracket mounted to the vehicle roof in an attachment area of the vehicle roof. The bracket can cover the attachment area. The bracket can include a cantilevered portion that extends in a vehicle-forward direction from the forwardmost point of the attachment area. The sensor assembly can include a sensor mounted to the cantilevered portion forward of the forwardmost point.

The bracket of the sensor assembly can be connected to a reinforcing beam, in which the reinforcing beam can be connected to a first structural component at a first side of an exterior surface of a vehicle that includes the sensor assembly.

The reinforcing beam can be connected to a second structural component at a second side of the exterior surface of the vehicle.

An area defined by a vertically projection of the cantilevered portion downward onto the vehicle roof can be outside of a windshield of a vehicle that includes the sensor assembly.

The bracket and the sensor mounted within the bracket can have a combined structural resonance frequency of greater than 2.5 hertz.

The bracket can include two members to support the cantilevered portion, the support members can be separated in a vehicle-lateral direction by a gap of between about 200 millimeters and about 400 millimeters.

The cantilevered portion can include a bottom panel supporting the sensor, the bottom panel being positioned between about 40 millimeters and about 80 millimeters vertically above the vehicle roof.

The sensor can be a lidar sensor.

The bracket can be arranged to restrict displacement of the sensor to between about 3.5 millimeters and about 8.0 millimeters in any direction with respect to the vehicle roof.

The bracket can be sized to restrict angular displacement to between about 1.0 degree and about 3.0 degrees with respect to a longitudinal axis of a vehicle including the sensor assembly.

The sensor assembly can additionally include a fan positioned in the cantilevered portion, in which the cantilevered portion includes a bottom panel supporting the sensor, and the fan can be positioned to draw airflow into the cantilevered portion through an opening in the bottom panel of the cantilevered portion.

The fan can be coupled to an air passage that extends from the fan and away from the bottom panel.

The cantilevered portion can include a top panel positioned vertically upward from the sensor, the cantilevered portion defines an air passage to permit airflow to pass directly above the sensor and directly below the top panel.

The cantilevered portion can include an outlet air vent positioned to receive the airflow from the fan and to supply the airflow to a sensing surface of the sensor.

The cantilevered portion can include an outlet air vent that extends in a vehicle-lateral direction to supply the airflow across a sensing surface of the sensor in a vertically downward direction.

The bracket of the sensor assembly can include two support members supporting the cantilevered portion, in which the support members are separated in a vehicle-lateral direction, and the opening is located between the support members along the vehicle-lateral direction.

The sensor assembly can additionally include a nozzle positioned in the cantilevered portion that is fluidly coupled to a washer fluid reservoir of a vehicle that includes the sensor assembly.

The sensor assembly can additionally include a first nozzle positioned in the cantilevered portion and aimed at a first portion of a sensing surface of the sensor. The sensor assembly can additionally include a second nozzle positioned in the cantilevered portion and aimed at a second portion of the sensing surface of the sensor, wherein the first and second portions of the sensing surface are non-overlapping.

The cantilevered portion can be positioned to provide a field-of-view of the sensor that includes a vehicle-forward portion of a hood of a vehicle that includes the sensor assembly.

A bottom panel and a top panel of the cantilevered portion can each be shaped so as to provide an airflow velocity at the bottom panel that is equal to the airflow velocity at the top panel during vehicle travel in a forward direction.

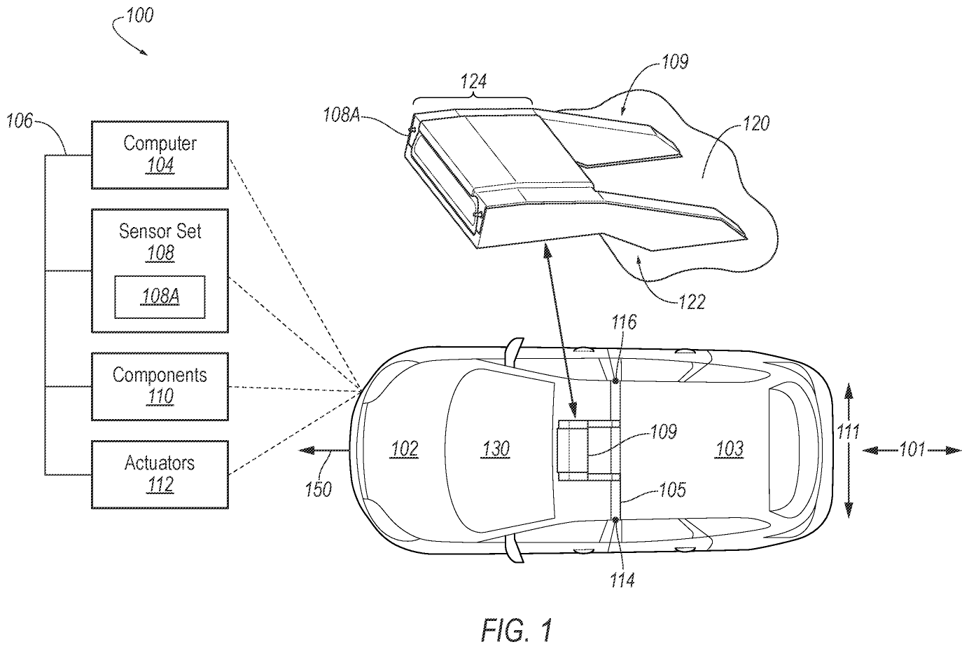

With reference to the Figures, wherein like numerals indicate like parts throughout the several views, FIG. 1 is a block diagram of an example vehicle having a cantilevered sensor assembly. Vehicle 100 can include a land vehicle, such as a car, truck, a sport utility vehicle, a crossover, a van, a minivan, a taxi, a bus, etc.

Vehicle 100 includes vehicle body 102. Vehicle 100 may be of a unibody construction, in which a frame and body 102 of vehicle 100 are a single component. Vehicle 100 may, alternatively, be of a body-on-frame construction, in which the frame supports body 102 that is a separate component from the frame. In accordance with body-on-frame construction of vehicle body 102, vehicle body 102 includes two components, which may include a body component and a frame component. A body component of vehicle body 102 may include a basic structure that forms the cabin, engine bay, and cargo area. The body component may be fixed to a frame, which supports the vehicle's weight and retains the suspension components of vehicle body 102. Vehicle body 102 or frame may include first structural component 114, second structural component 116, and reinforcing beam 105. First structural component 114 and second structural component 116 may include roof rails on opposite lateral sides of vehicle 100. The frame and body 102 may be formed of any suitable material, for example, steel, aluminum, etc.

Vehicle 100 may additionally include computer 104, which may utilize vehicle communications bus 106 to communicate with sensor set 108, vehicle components 110, actuators 112, human-machine interface (HMI), and a communication subsystem. Computer 104 may include programming to operate one or more brakes of vehicle 100, propulsion (e.g., control of acceleration in the vehicle by controlling one or more of an internal combustion engine, electric motor, hybrid engine, etc.), steering, climate control, interior and/or exterior lights, etc. Vehicle communications bus 106 can include an internal wired and/or wireless network, such as a controller area network (CAN) or the like, and/or other wired and/or wireless mechanisms. Vehicle computer 104 includes a processor and a memory, which can include one or more forms of computer-readable media, and stores instructions executable by vehicle computer 104 for performing various operations, including those disclosed herein. Vehicle computer 104 may include or be communicatively coupled to more than one processor, e.g., included in electronic controller units (ECUs) or the like included in vehicle 100 for monitoring, actuating, and/or controlling various vehicle actuators 112, e.g., a powertrain actuator, a brake actuator, a steering actuator, electromechanical actuators etc. Further, vehicle computer 104 may receive signals, via a communications subsystem, from a satellite positioning system, e.g., GPS.

Sensor set 108 of vehicle 100 can include any sensor for detecting the attributes of an environment external to vehicle 100, such as objects and/or characteristics of surroundings of the vehicle. Accordingly, sensor set 108 may operate to detect other vehicles, road markings, traffic lights and/or signs, pedestrians, natural objects, etc. For example, sensor set 108 may include radar sensors, ultrasonic sensors, lidar devices (e.g., sensor 108A), and image processing sensors such as cameras. As an example, vehicle computer 104 may obtain an estimate of the position of vehicle 100, which may include, for example, fusing output data from sensor set 108 with satellite positioning signals from GPS satellites. The location data may be in a known form, e.g., geo-coordinates in a global-reference frame (i.e., latitudinal and longitudinal). Sensors of sensors set 108 can include any number of additional devices, which may be mounted at a top portion of vehicle body 102, at a rear portion of vehicle body 102, at windshield 130, around vehicle body 102, etc. Such sensors may provide relative locations, sizes, and shapes of objects and/or conditions surrounding vehicle body 102. Sensors of sensor set 108 may cooperate with each other to provide sensor fusion capabilities. For example, sensor 108A may include a lidar sensor, which may cooperate with a camera sensor to provide, for example, a range to a camera-detected object. Thus, in one example, a camera device of sensor set 108 may capture an image of a stationary or moving object located in a forward direction with respect to vehicle 100. Sensor 108A (e.g., a lidar sensor) may then provide range data, which may permit sensor fusion processing programming of computer 104 to determine a distance between the camera-detected object and vehicle 100.

Windshield 130 may be mounted to vehicle body 102. Windshield 130 may extend from the front hood of vehicle body 102 and terminate at a front portion of vehicle roof 103. Windshield 130 may be formed from any suitably durable transparent material, including glass such as laminated, tempered glass or plastic such as Plexiglas® or polycarbonate.

Vehicle roof 103 may extend from the rear edge of windshield 130 to provide an upper boundary of the cabin of vehicle 100. Vehicle roof 103 may be formed of any suitably durable transparent material, including glass such as laminated, tempered glass or plastic such as Plexiglas® or polycarbonate. The transparent material permits operators and passengers of vehicle 100 to view objects located to the front of the vehicle as well as objects located above the vehicle as the vehicle proceeds along path 150.

Vehicle roof 103 may be supported, at least in part, by reinforcing beam 105. Reinforcing beam 105 may be connected to first structural component 114 at a first lateral side or edge of vehicle body 102 (e.g., the left side) and may be connected to second structural component 116 at a second lateral side or edge of vehicle body 102 (e.g., the right side). Reinforcing beam 105 may support vehicle roof 103 for an entire lateral width of vehicle roof 103. Reinforcing beam 105 may be formed from any suitable material, such as steel, aluminum, etc.

Sensor bracket 109 may be fixed to reinforcing beam 105, such as shown in FIG. 1. Accordingly, sensor bracket 109 can be rigidly supported, such as by way of reinforcing beam 105 attached to first structural component 114 and second structural component 116 to vehicle body 102.

As shown in FIG. 1, sensor bracket 109, which may surround and support sensor 108A, may be positioned at a location outside of the area encompassed by windshield 130. A forwardmost point of sensor bracket 109 may be longitudinally behind a rearwardmost point of windshield 130. The positioning of sensor bracket 109 outside of the area encompassed by windshield 130 may provide the operator of vehicle 100 with an unobstructed view of areas forward of the vehicle. Sensor bracket 109 can be formed any suitable materials, such as a synthetic polymer, acrylonitrile butadiene styrene (ABS) plastic, polycarbonate, an acetal copolymer, an acetal homopolymer, etc. The strength and load-bearing properties of sensor bracket 109 may be augmented by the addition of metallic components, such as metallic stiffening rods, ribs, etc.

Sensor bracket 109 may be sized so as to support sensor 108A, which may include a weight of between 1.5 kilograms and 3.0 kilograms. In an example, sizing of bracket 109 can restrict movement, e.g., displacement, of sensor 108A to between about 3.5 millimeters and about 8.0 millimeters in any direction (e.g., along vehicle longitudinal axis 101 and/or along lateral direction 111) with respect to vehicle roof 103. In an example, sizing of bracket 109 can additionally restrict angular displacement of sensor 108A to between about 1.0 degree and about 3.0 degrees with respect to vehicle longitudinal axis 101. Accordingly, programming of computer 104 can execute sensor fusion operations, such as by combining output data from a camera of sensor set 108 with range data output from sensor 108A. Thus, in response to image processing programming of computer 104 detecting and classifying a static or moving object in the driving environment of vehicle 100, programming of computer 104 may utilize output signals from sensor 108A to determine the range to the static or moving object. In the example of FIG. 1, sensor 108A can be positioned within and supported by sensor bracket 109. Sensor bracket 109 may be mounted to vehicle roof 103 at attachment area 120. Cantilevered portion 124 of sensor bracket 109 is shown as being located forward of forwardmost point 122 of attachment area 120. Attachment area 120 can coincide with or overlap reinforcing beam 105, thereby permitting sensor bracket 109 to be coupled to and supported by the reinforcing beam 105, which may be positioned directly beneath attachment area 120. A lateral midpoint of sensor bracket 109 may coincide with vehicle longitudinal axis 101; i.e., sensor bracket 109 may be laterally centered on vehicle longitudinal axis 101. Sensor 108A may be housed within sensor bracket 109, e.g., between bottom panel 315 and top panel 320 (further described in relation to FIG. 3). Top panel 320 may be positioned between about 40 millimeters and about 80 millimeters in a direction that is vertically upward from vehicle roof 103. Accordingly, as described in greater detail in reference to FIG. 8, sensor 108A can be provided with a field-of-view that permits sensor 108A to receive reflected lidar signals from static or moving objects located at relatively short distances from vehicle body 102, such as, immediately in front of the vehicle. In addition, sensor 108A may include a field-of-view that permits the sensor to receive reflected lidar signals from static or moving objects located at greater distances from the vehicle body, such as distances of 100 meters, 500 meters, 1.0 kilometer, etc.

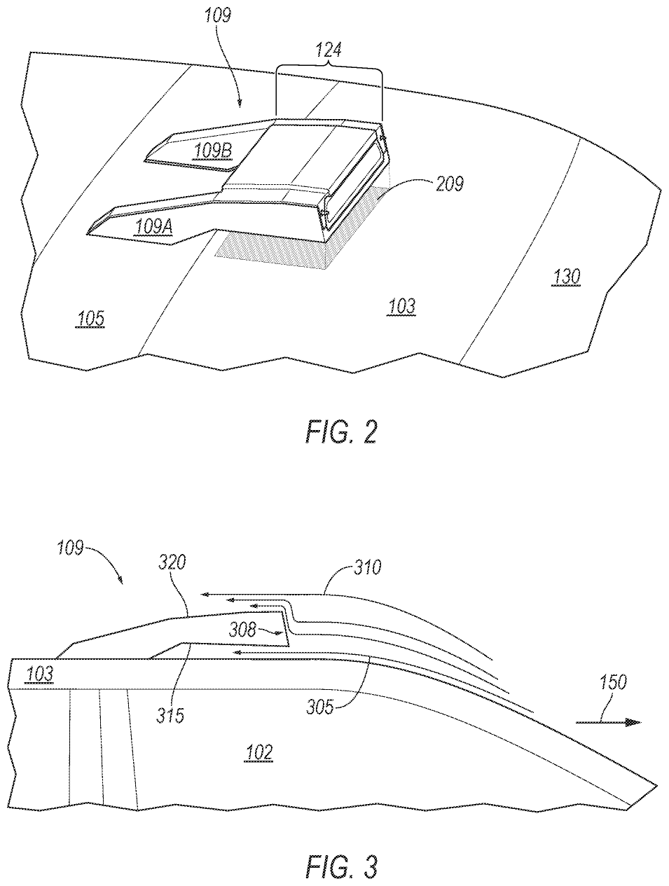

FIG. 2 is a perspective view showing a cantilevered sensor assembly mounted on vehicle roof 103. As shown in FIG. 2, cantilevered portion 124 of sensor bracket 109 presents vertically downward projection 209 onto vehicle roof 103. In this context a “projection” is used in a mathematical sense of a transformation of points and lines onto a plane by connecting corresponding points with parallel lines, which, in this instance, include vertical parallel lines. The features of cantilevered portion 124 are projected vertically downward onto vehicle roof 103 to define vertically downward projection 209. In other words, vertically downward projection 209 represents a “footprint” or area of cantilevered portion 124 on vehicle roof 103. Vertically downward projection 209 defines an area that lies outside of the area occupied by windshield 130 and, in the example of FIG. 2, lies entirely within the boundaries of vehicle roof 103. Thus, as previously mentioned, cantilevered portion 124 of sensor bracket 109 provides an operator of vehicle 100 with an unobstructed view in directions forward of the vehicle 100.

Sensor bracket 109 can include support members 109A and 109B, which may be mounted to reinforcing beam 105 at attachment area 120. Cantilevered portion 124 of sensor bracket 109, supported by support members 109A and 109B, is shown as being located forward of attachment area 120 as described in reference to FIG. 1. Support members 109A can be formed from any suitable materials, such as a synthetic polymer, acrylonitrile butadiene styrene plastic, polycarbonate, an acetal copolymer, an acetal homopolymer, etc. The strength and load-bearing properties of support members 109A and 109B may be augmented by the addition of metallic components, such as stiffening rods, ribs, etc. Support members 109A and 109B are separated in a vehicle-lateral direction by an opening between the support members along the vehicle-lateral direction 111.

Sensor bracket 109 can be formed from any suitable material capable of supporting a sensor, e.g., sensor 108A having a weight of between 1.5 and 3.0 kilograms, while vehicle body 102 proceeds along path 150. Structural properties and features of sensor bracket 109, in combination with sensor 108A, e.g., located within and supported by cantilevered portion 124, can be analyzed utilizing any suitable computerized structural modeling tool. For example, elements of sensor bracket 109, within which sensor 108A is mounted, may be analyzed using a finite element analysis technique. In an example, elements of sensor bracket 109 can be analyzed utilizing Ansys Mechanical Finite Element Analysis (FEA) Software for Structural Engineering available from ANSYS, Inc., located at 2600 Ansys Drive Canonsburg, PA 15317, USA. In an example, sensor bracket 109 housing sensor 108A can be designed to include a structural resonance frequency of greater than 2.5 hertz. In an example, via designing of sensor bracket 109 to include a structural resonance frequency of greater than 2.5 hertz, effects of structural oscillations resulting from wind loading during vehicle travel (e.g., along path 150) at various vehicle speeds can be minimized. In an example, to achieve a structural resonance frequency of greater than 2.5 hertz, the shape and composition of support members 109A and 109B of bracket 109 may be adjusted to add mass to the structural elements, add stiffening or reinforcing material, or modify bracket 109 in another way to adjust the structural resonance of the bracket. In an example, by moving the structural resonance frequency to greater than 2.5 hertz, vibrations brought about by wind loading during vehicle travel can be adjusted to, for example, 2.75 hertz, 3.0 hertz, 5.0 hertz, etc.

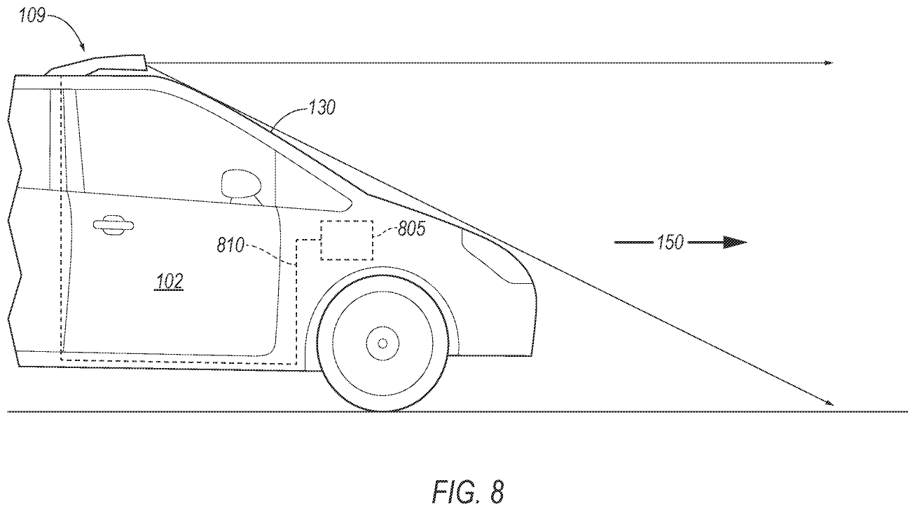

FIG. 3 is a side view showing airflow in relation to top panel 320 and bottom panel 315 of a cantilevered sensor assembly. As shown in FIG. 3 (and in FIG. 7) top panel 320 represents a structure that extends in the direction of vehicle longitudinal axis 101 and in lateral direction 111. Top panel 320 is positioned directly above sensor 108A and partially encloses sensor 108A.

Bottom panel 315, which abuts and is fixed to support members 109A and 109B, cooperates with the support members to bear the weight of sensor 108A. Accordingly, bottom panel 315, top panel 320, and support members 109A and 109B, cooperate to form an enclosure that protects sensor 108A from weather, such as sunlight, rain, intrusion of dust, dirt, and/or other contaminants. Sensor 108A can be secured to bottom panel 315 so as to prevent movement of sensor 108A within an enclosure formed by the support members 109A-B, the top panel 320, and the bottom panel 315 of the cantilevered sensor assembly depicted in FIG. 3.

As shown in FIG. 3, during forward motion of vehicle body 102 along path 150, airflow 305 may pass beneath bottom panel 315 while airflow 310 may travel in a vertical upward direction and over top panel 320. In an example, bottom panel 315 and top panel 320 may be sized and/or shaped so as to provide an airflow quantity and velocity at bottom panel 315 that is equal to the airflow quantity and velocity at top panel 320 during vehicle travel in a forward direction. Accordingly, the sizing of bottom panel 315 and top panel 320 may prevent vehicle forward motion from producing aerodynamic lift of sensor bracket 109 in a vertically upward direction. In an example, by preventing aerodynamic lift of sensor bracket 109, which may result in the movement of sensor bracket 109 in an upward or downward direction with respect to vehicle roof 103, the bracket may remain fixed in relation to vehicle roof 103.

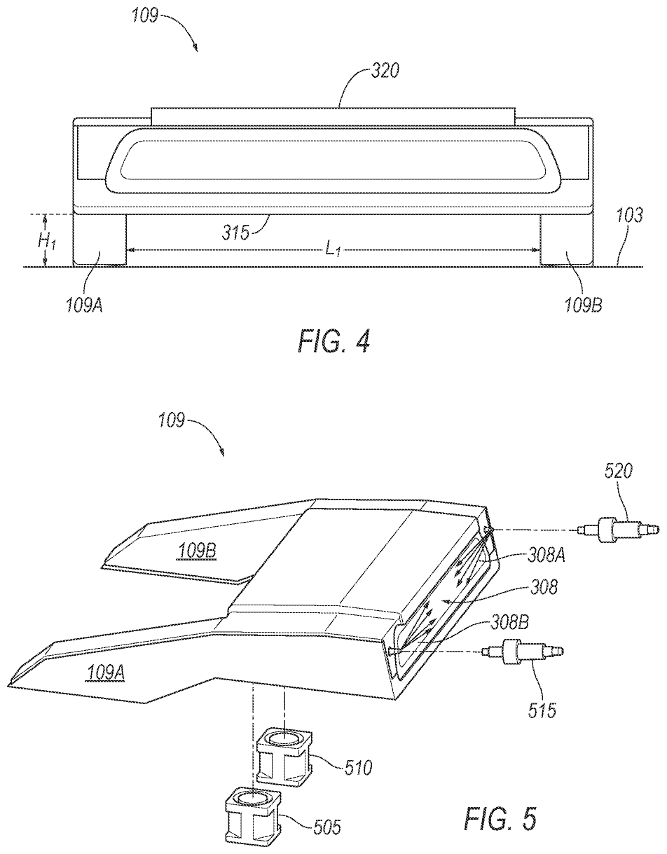

FIG. 4 is a front view of a cantilevered sensor assembly mounted to vehicle roof 103. Sensor bracket 109 includes two support members 109A, 109B. As shown in FIG. 4, support members 109A and 109B may be separated by a distance Li. In examples, a gap or opening between support members 109A and 109B, as shown by distance Li, may range from between about 200 millimeters to about 400 millimeters thereby accommodating a wide range of shapes and sizes of sensor 108A. Also as shown in FIG. 1, lateral edges of bottom panel 315 may be attached to support members 109A and 109B. Support members 109A and 109B can operate to position bottom panel 315 at a distance (Hi) from vehicle roof 103. Distance Hi may be between about 40 millimeters and about 80 millimeters in a vertically upward direction with respect to vehicle roof 103. In an example, via positioning of bottom panel 315 at a distance of between about 40 millimeters and about 80 millimeters in a vertically upward direction with respect to vehicle roof 103, the sensor bracket 109 may be at least partially insulated from vehicle roof 103. Such separation between bottom panel 315 and vehicle roof 103 may diminish the amount of heat transmitted from vehicle roof 103 to sensor bracket 109 and sensor 108A in response to sun-loading on vehicle roof 103.

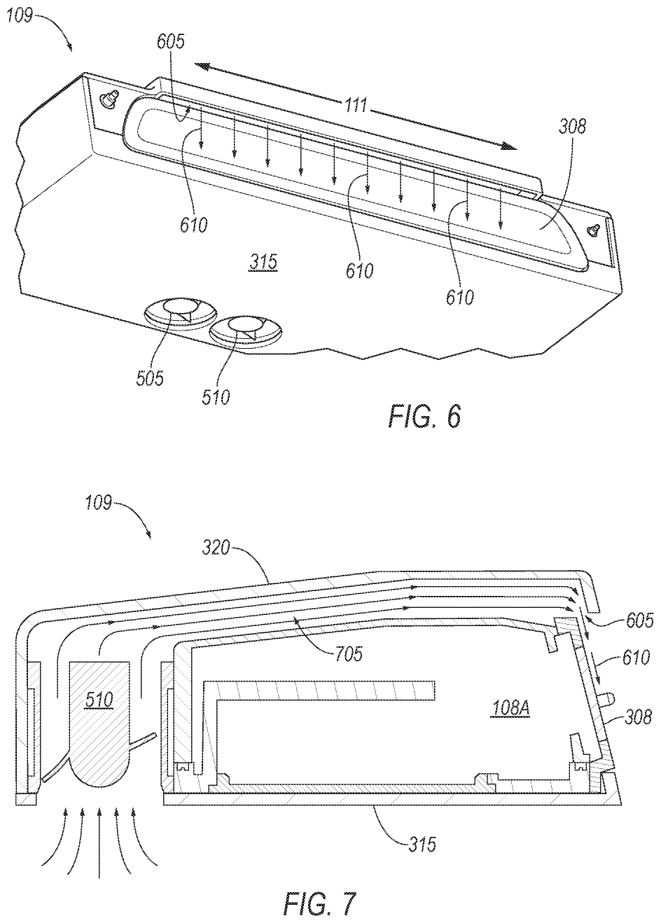

FIG. 5 is an exploded perspective view of a cantilevered sensor assembly showing cooling fans 505 and 510 and nozzles 515 and 520. In the example of FIG. 5, cooling fans 505 and 510 may be positioned at an opening within bottom panel 315 of cantilevered portion 124 at a location to the rear of sensor 108A. Cooling fans 505 and 510 may thus be capable of drawing airflow from areas near bottom panel 315 and into an air passage (e.g., air passage 705 of FIG. 7) within sensor bracket 109. Top panel 320 of cantilevered portion 124 may thus define an air passage to permit airflow to pass directly above sensor 108A and directly below the top panel, thereby drawing excess heat from sensor 108A for dispensing to locations outside of sensor bracket 109 (e.g., outlet air vent 605 of FIG. 6). Accordingly, cooling fans 505 and 510 may operate to remove excess heat from sensor 108A and may additionally operate to dislodge dust particles and/or other contaminants from sensing surface 308 of sensor 108A. Cooling fans 505 and 510 may be located at a rear edge of bottom panel 315, e.g., between support members 109A and 109B. The rearward position of cooling fans 505 and 510 may permit smooth airflow between bottom panel 315 and vehicle roof 103.

First nozzle 515 and second nozzle 520 may be aimed in the direction of sensing surface 308 of sensor 108A. In the example of FIG. 5, first nozzle 515 may be aimed so as to dispense washer fluid, for example, to a first portion (e.g., 308A) of sensing surface 308. Also in the example of FIG. 5, second nozzle 520 may be aimed so as to dispense washer fluid to a second portion (e.g., 308B) of sensing surface 308. In an example, first portion 308A and second portion 308B are non-overlapping. As shown in reference to FIG. 8, first nozzle 515 and second nozzle 520 may be fluidly coupled to a washer fluid reservoir (e.g., 805), which may be intermittently activated so as to provide an additional capability to remove or dislodge dust and/or other contaminants (e.g., mud, dirt, insects, etc.) from sensing surface 308.

FIG. 6 is a bottom perspective view of airflow 610 across surface 308 of sensor 108A of a cantilevered sensor assembly. As seen in FIG. 6, responsive to cooling fans 505 and 510 drawing airflow from areas near bottom panel 315, the airflow can be dispensed via outlet air vent 605 in a vertically downward direction across sensing surface 308. In the example of FIG. 6, outlet air vent 605 can extend in vehicle-lateral direction 111. For example, outlet air vent 605 may be a slot elongated along a top edge of sensing surface 308. Accordingly, as previously described in relation to FIG. 5, cooling fans 505 and 510 may operate to maintain a suitable temperature for sensor 108A and to maintain airflow across sensing surface 308.

FIG. 7 is a cross-sectional side view showing an air passage internal to a cantilevered sensor assembly. As seen in FIG. 7, example cooling fan 510 may draw airflow from areas near bottom panel 315 into air passage 705. Air passage 705 is shown as extending from cooling fan 510 to outlet air vent 605. Air passage 705 can be bounded by an upper surface of sensor 108A and a bottom surface of top panel 320. The airflow thus provides cooling to sensor 108A. Top panel 320 defines an upper boundary of air passage 705 between top panel 320 and an upward-facing surface of sensor 108A. Accordingly, top panel 320 permits airflow to be directed, such as via cooling fans 505 and 510 (described in reference to FIG. 5), into direct contact with an upward-facing surface of sensor 108A. As shown in FIG. 3, airflow may be directed from locations to the rear of sensor 108A and in a vehicle-forward direction to an outlet air vent (e.g., 605 of FIG. 7).

FIG. 8 is a side view of a cantilevered sensor assembly showing a vertical extent of a field-of-view of the sensor. As shown in FIG. 8, the cantilevered sensor assembly is positioned to provide a field-of-view of sensor 108A that includes a vehicle-forward portion of a hood of vehicle body 102. As described in reference to FIG. 3, bottom panel 315 may be positioned at a distance of between about 40 millimeters and about 80 millimeters in a vertically upward direction with respect to vehicle roof 103. Accordingly, sensor 108A can be provided with a field-of-view that permits sensor 108A to receive reflected lidar signals from static or moving objects located in a vehicle-forward at relatively short distances from vehicle body 102, such as immediately in front of the vehicle. In addition, sensor 108A may include a field-of-view that permits the sensor to receive reflected lidar signals from static or moving objects located at greater distances from the vehicle body, such as distances of 100 meters, 500 meters, 1.0 kilometer, etc.

FIG. 8 additionally depicts washer fluid reservoir 805, which may be fluidly coupled, e.g., via fluid conduit 810, with first and second nozzles 515 and 520. Thus, in an example, in response to vehicle computer 104 determining that sensing surface 308 may benefit from cleaning in addition to cleaning provided by airflow generated by one or more of cooling fans 505 and 510, a washer fluid pump (not shown in FIG. 8) can actuate additional cleaning of the sensing surface.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above and are accessed via a network in any one or more of a variety of manners. A file system may be accessible from a computer operating system and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It should further be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. The adjectives “first,” “second,” and “third” are used throughout this document as identifiers and are not intended to signify importance, order, or quantity. Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A sensor assembly, comprising:
a vehicle roof;
a bracket mounted to the vehicle roof in an attachment area of the vehicle roof, the bracket covering the attachment area, the bracket having a cantilevered portion extending in a vehicle-forward direction from a forwardmost point of the attachment area; and
a sensor mounted to the cantilevered portion forward of the forwardmost point.

2. The sensor assembly of claim 1, wherein the bracket is connected to a reinforcing beam, and wherein the reinforcing beam is connected to a first structural component at a first side of a vehicle that includes the sensor assembly.

3. The sensor assembly of claim 2, wherein the reinforcing beam is connected to a second structural component at a second side of the vehicle.

4. The sensor assembly of claim 1, wherein an area defined by vertically projecting the cantilevered portion downward onto the vehicle roof is outside of a windshield of a vehicle that includes the sensor assembly.

5. The sensor assembly of claim 1, wherein the bracket and the sensor mounted within the bracket have a combined structural resonance frequency of greater than 2.5 hertz.

6. The sensor assembly of claim 1, wherein the bracket includes two support members supporting the cantilevered portion, the support members being separated in a vehicle-lateral direction by a gap of between about 200 millimeters and about 400 millimeters.

7. The sensor assembly of claim 1, wherein the cantilevered portion includes a bottom panel supporting the sensor, the bottom panel being positioned between about 40 millimeters and about 80 millimeters vertically above the vehicle roof.

8. The sensor assembly of claim 1, wherein the sensor is a lidar sensor.

9. The sensor assembly of claim 1, wherein the bracket is arranged to restrict displacement of the sensor to between about 3.5 millimeters and about 8.0 millimeters in any direction with respect to the vehicle roof.

10. The sensor assembly of claim 1, wherein the bracket is sized to restrict angular displacement to between 1.0 degree and 3.0 degrees with respect to a longitudinal axis of a vehicle including the sensor assembly.

11. The sensor assembly of claim 1, further comprising a fan positioned in the cantilevered portion, wherein the cantilevered portion includes a bottom panel supporting the sensor, and the fan is positioned to draw airflow into the cantilevered portion through an opening in the bottom panel of the cantilevered portion.

12. The sensor assembly of claim 11, wherein the fan is coupled to an air passage that extends from the fan and away from the bottom panel.

13. The sensor assembly of claim 11, wherein the cantilevered portion includes a top panel positioned vertically upward from the sensor, the cantilevered portion defines an air passage to permit airflow to pass directly above the sensor and directly below the top panel.

14. The sensor assembly of claim 11, wherein the cantilevered portion includes an outlet air vent positioned to receive the airflow from the fan and to supply the airflow to a sensing surface of the sensor.

15. The sensor assembly of claim 11, wherein the cantilevered portion includes an outlet air vent that extends in a vehicle-lateral direction to supply the airflow across a sensing surface of the sensor in a vertically downward direction.

16. The sensor assembly of claim 11, wherein the bracket includes two support members supporting the cantilevered portion, the support members being separated in a vehicle-lateral direction, and the opening is located between the support members along a vehicle-lateral direction.

17. The sensor assembly of claim 1, further comprising a nozzle positioned in the cantilevered portion that is fluidly coupled to a washer fluid reservoir of a vehicle that includes the sensor assembly.

18. The sensor assembly of claim 1, further comprising:
a first nozzle positioned in the cantilevered portion and aimed at a first portion of a sensing surface of the sensor; and
a second nozzle positioned in the cantilevered portion and aimed at a second portion of the sensing surface of the sensor, wherein the first and second portions of the sensing surface are non-overlapping.

19. The sensor assembly of claim 1, wherein the cantilevered portion is positioned to provide a field-of-view of the sensor that includes a vehicle-forward portion of a hood of a vehicle that includes the sensor assembly.

20. The sensor assembly of claim 1, wherein a bottom panel and a top panel of the cantilevered portion are each shaped so as to provide an airflow velocity at the bottom panel that is equal to the airflow velocity at the top panel during vehicle travel in a forward direction.
